(19) United States
(12) Patent Application Publication
(10) Pub. No.: US 2026/0195811 A1
(43) Pub. Date: Jul. 9, 2026

(54) METHOD AND SYSTEM TO PERFORM AUTOMATED RISK GRADING FOR ASSETS

(71) Applicant: JPMorgan Chase Bank, N.A., New York, NY (US)

(72) Inventors: Vikash Kumar JANGID, Bengaluru (IN); Sahana BHASKAR, Bangalore (IN); Naveen KUMAR S, Bangalore (IN)

(73) Assignee: JPMorgan Chase Bank, N.A., New York, NY (US)

(21) Appl. No.: 19/058,965

(22) Filed: Feb. 20, 2025

(30) Foreign Application Priority Data
Jan. 6, 2025 (IN) 202511001173

(51) Int. Cl. G06Q 40/03

(52) U.S. Cl. CPC G06Q 40/03

(57) ABSTRACT

A method and system to perform an automated risk grading for assets are disclosed. The method includes receiving, a plurality of data sets from a plurality of services in response to a grading request. The method also includes storing the plurality of data sets in a database and aggregating the plurality of data sets. The method also includes providing first and second aggregated data sets out of the data sets to a first engine and a second engine, respectively. The method also includes configuring and executing at least one simulation test and at least one assessment test using the first engine and the second engine to generate an intermediate result. The method also includes transmitting the intermediate result to a grading module. The method also includes processing, using the grading module, the intermediate result to generate at least one grading output for the grading request.

### CROSS-REFERENCE TO RELATED APPLICATIONS

This application claims priority benefit from Indian Application No. 202511001173, filed on Jan. 6, 2025 in the India Patent Office, which is hereby incorporated by reference in its entirety.

### FIELD OF THE DISCLOSURE

This technology generally relates to risk management and more particularly, relates to methods and systems to perform an automated risk grading for various types of assets.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Lending and risk assessment are critical aspects of financial management that ensure the stability and profitability of financial institutions. These processes are integral to managing credit risk, optimizing portfolio performance, and in making an informed lending decisions. For planning and accepting loan-related operations or activities, it is necessary to check the risks of a client for a high-performing business need such as commercial properties or assets. Commercial properties or assets may include such as, but are not limited to, shopping malls, warehouses, and apartment buildings. These commercial properties may generate rental income or may provide commercial benefits. Risk grading is one way of checking the credit risks of such assets based on the systematic assessment of an asset's credit quality or investment risk. It involves assigning a risk grade or rating to each asset based on various risk factors. This grading may help institutions in understanding the relative risk associated with each asset and in making strategic decisions to manage that risk effectively. Currently, the grading of the commercial assets is also performed based on the generated income. However, such grading of the user or borrower and commercial properties or assets is done manually, which is error-prone and time-consuming in managing loan-related operations and activities. Consistently assessing risk for loan portfolios is a key differentiator in the financial risk management process of banks.

Hence, in view of these and other existing limitations, there arises an imperative need to provide an efficient solution to overcome the above-mentioned limitations and to provide a method and system that can provide an automated risk grading for commercial real estate loan portfolios.

### SUMMARY

The present disclosure, through one or more of its various aspects, embodiments, and/or specific features or sub-components, provides, inter alias, various systems, servers, devices, methods, media, programs, and platforms for performing an automated risk grading for assets.

According to an aspect of the present disclosure, a method to perform an automated risk grading for assets is disclosed. The method may be implemented by at least one processor. The method may include receiving, by the at least one processor, a plurality of data sets from a plurality of services in response to a grading request. The method may also include storing, by the at least one processor, the plurality of data sets in a database. Next, the method may also include aggregating, by the at least one processor, the plurality of data sets. The method may include providing, by the at least one processor, a first aggregated data set and a second aggregated data set out of the plurality of data sets to a first engine and a second engine, respectively. The method may include configuring, by the at least one processor using the first engine, at least one simulation test in accordance with the grading request and the first aggregated data set. The method may include configuring, by the at least one processor using the second engine, at least one assessment test based on a predefined format and the second aggregated data set. The method may also include executing, by the at least one processor, the at least one simulation test using the first engine and the at least one assessment test using the second engine to generate an intermediate result. The method may also include transmitting, by the at least one processor, the intermediate result to a grading module. Thereafter, the method may also include processing, by the at least one processor using the grading module, the intermediate result to generate at least one grading output for the grading request.

In accordance with an exemplary embodiment, the grading request includes at least one from among details of an asset, a property type of the asset, a line of business, and a plurality of simulation parameters.

In accordance with an exemplary embodiment, the plurality of simulation parameters includes at least one from among a net operating income change, an interest rate, a change in asset value, stress types, and regions.

In accordance with an exemplary embodiment, the plurality of services includes at least one from among a loan servicing data service, a credit data service, a portfolio data service, an origination data service, and a client data service.

In accordance with an exemplary embodiment, the first aggregated data set includes data required for configuring the at least one simulation test.

In accordance with an exemplary embodiment, the second aggregated data set includes data required for configuring the at least one assessment test.

In accordance with an exemplary embodiment, the method further includes displaying, by the at least one processor over a user interface (UI), the at least one grading output.

In accordance with an exemplary embodiment, generating the intermediate result is further based on receiving a response from at least one external service in response to a request received from at least one of the first engine and the second engine.

According to another aspect of the present disclosure, a computing device configured to perform an automated risk grading for assets is disclosed. The computing device includes a processor; a memory; and a communication interface coupled to each of the processor and the memory. The processor may be configured to receive a plurality of data sets from a plurality of services in response to a grading request. The processor may also be configured to store the plurality of data sets in a database. The processor may also be configured to aggregate the plurality of data sets. The processor may also be configured to provide a first aggregated data set and a second aggregated data set out of the plurality of data sets to a first engine and a second engine, respectively. The processor may also be configured, using the first engine, at least one simulation test in accordance with the grading request and the first aggregated data set. The processor may also be configured, using the second engine, at least one assessment test based on a predefined format and the second aggregated data set. The processor may also be configured to execute the at least one simulation test using the first engine and the at least one assessment test using the second engine to generate an intermediate result. The processor may also be configured to transmit the intermediate result to a grading module. The processor may also be configured to process, using the grading module, the intermediate result to generate at least one grading output for the grading request.

In accordance with an exemplary embodiment, the grading request includes at least one from among details of an asset, a property type of the asset, a line of business, and a plurality of simulation parameters.

In accordance with an exemplary embodiment, the plurality of simulation parameters includes at least one from among a net operating income change, an interest rate, a change in asset value, stress types, and regions.

In accordance with an exemplary embodiment, the plurality of services includes at least one from among a loan servicing data service, a credit data service, a portfolio data service, an origination data service, and a client data service.

In accordance with an exemplary embodiment, the first aggregated data set includes data required for configuring the at least one simulation test.

In accordance with an exemplary embodiment, the second aggregated data set includes data required for configuring the at least one assessment test.

In accordance with an exemplary embodiment, the processor is further configured to display the at least one grading output over a user interface (UI).

In accordance with an exemplary embodiment, generation of the intermediate result is further based on a reception of a response from at least one external service against a request received from at least one of the first engine and the second engine.

According to yet another aspect of the present disclosure, a non-transitory computer-readable storage medium storing instructions to perform an automated risk grading for assets is disclosed. The instructions include executable code which, when executed by a processor, may cause the processor to receive a plurality of data sets from a plurality of services in response to a grading request; store the plurality of data sets in a database; aggregate the plurality of data sets; provide a first aggregated data set and a second aggregated data set out of the plurality of data sets to a first engine and a second engine, respectively; configure, using the first engine, at least one simulation test in accordance with the grading request and the first aggregated data set; configure, using the second engine, at least one assessment test based on a predefined format and the second aggregated data set; execute the at least one simulation test using the first engine and the at least one assessment test using the second engine to generate an intermediate result; transmit the intermediate result to a grading module; and process, using the grading module, the intermediate result to generate at least one grading output for the grading request.

In accordance with an exemplary embodiment, the grading request includes at least one from among details of an asset, a property type of the asset, a line of business, and a plurality of simulation parameters.

In accordance with an exemplary embodiment, the plurality of simulation parameters includes at least one from among a net operating income change, an interest rate, a change in asset value, stress types, and regions.

In accordance with an exemplary embodiment, the first aggregated data set includes data required for configuring the at least one simulation test.

In accordance with an exemplary embodiment, the second aggregated data set includes data required for configuring the at least one assessment test.

In accordance with an exemplary embodiment, the executable code which, when executed by the processor, may cause the processor to display the at least one grading output over a user interface (UI).

In accordance with an exemplary embodiment, generation of the intermediate result is further based on a reception of a response from at least one external service against a request received from at least one of the first engine and the second engine.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system to perform an automated risk grading for assets in accordance with an exemplary embodiment of the present disclosure.

FIG. 2 illustrates an exemplary diagram of a network environment to perform an automated risk grading for assets in accordance with an exemplary embodiment of the present disclosure.

FIG. 3 illustrates a system diagram to perform an automated risk grading for assets in accordance with an exemplary embodiment of the present disclosure.

FIG. 4 illustrates an exemplary method flow diagram for performing automated risk grading for assets in accordance with an exemplary embodiment of the present disclosure.

FIG. 5 illustrates a block diagram representing a system to perform an automated risk grading for assets in accordance with an exemplary embodiment of the present disclosure.

FIG. 6 illustrates an exemplary system architecture depicting a process of performing automated risk grading for assets in accordance with an exemplary embodiment of the present disclosure.

### DETAILED DESCRIPTION

Exemplary embodiments now will be described with reference to the accompanying drawings. The present application may, however, be embodied in many different forms and should not be construed as limited to the embodiments set forth herein; rather, these embodiments are provided so as to be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to herein as being “connected” or “coupled” to another element, it can be directly connected or coupled to the other element or intervening elements may be present. Furthermore, “connected” or “coupled” as used herein may include wirelessly connected or coupled. As used herein, the term “and/or” may include any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this application pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures may include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

Risk grading is one way of checking the credit risks of commercial assets based on the systematic assessment of an asset's credit quality or investment risk. It involves assigning a risk grade or rating to each asset based on various risk factors. This grading helps financial institutions to understand the relative risk associated with each asset and make strategic decisions to manage that risk effectively. However, currently the grading of a user or borrower and commercial assets is done manually, which is error prone and time-consuming for managing loan related operations. Consistently and regularly assessing portfolio risk is a key differentiator in the financial risk management for banks. However, manual grading of the entire portfolio for such commercial assets on a daily or monthly basis is not feasible due to data entry errors and interpretations.

To overcome the above-mentioned problems, the present disclosure provides a method and system to perform an automated risk grading for assets. In the present disclosure, the system may receive a plurality of data sets from a plurality of services in response to a grading request. The system further stores the plurality of data sets in a database. Further, the system may aggregate the plurality of data sets. The system may also provide a first aggregated data set and a second aggregated data set out of the plurality of data sets to a first engine and a second engine, respectively. Further, the system may configure, using the first engine, at least one simulation test in accordance with the grading request and the first aggregated data set. The system may also configure, using the second engine, at least one assessment test based on a predefined format and the second aggregated data set. The system may execute the at least one simulation test using the first engine and the at least one assessment test using the second engine to generate an intermediate result. The system may also transmit the intermediate result to a grading module. Thereafter, the system may process, using the grading module, the intermediate result to generate at least one grading output for the grading request. This way the system performs an automated risk grading for commercial assets.

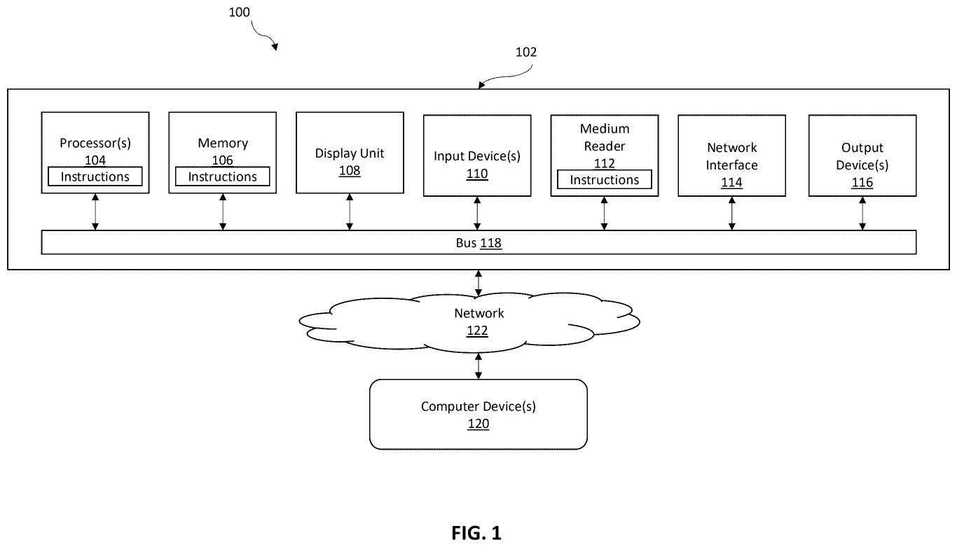

FIG. 1 is an exemplary system for use in accordance with the embodiments described herein. The system 100 is generally shown and may include a computer system 102 which is generally indicated. The term “computer system” may also be referred to herein as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. The instructions may also be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set or multiple sets of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that may include discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, high-density digital optical storage disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional or alternative input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, short-range wireless network, ZIGBEE®, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to perform an automated risk grading for assets.

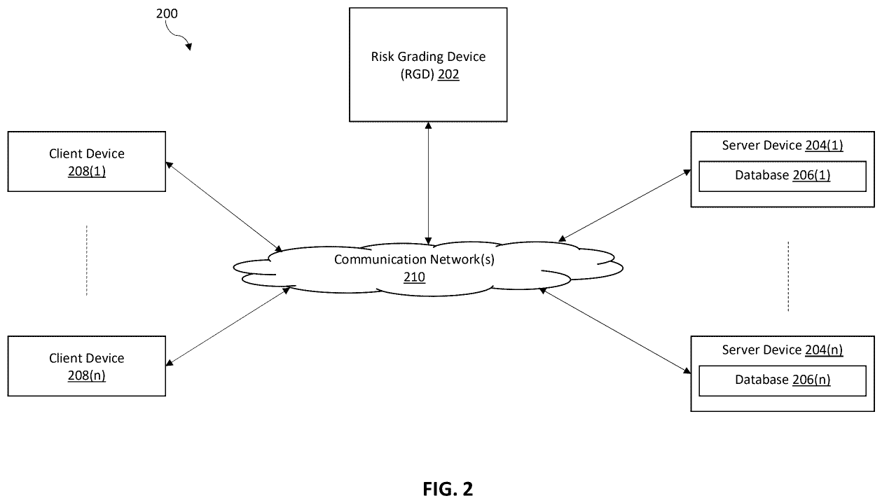

Referring to FIG. 2, a schematic of an exemplary network environment 200 to perform an automated risk grading for assets is illustrated. In an exemplary implementation, the method is executable on any networked computer platform, such as, for example, a personal computer (PC).

The method to perform an automated risk grading for assets may be executed by a risk grading device (RGD) 202. The RGD 202 may be the same or similar to the computer system 102 as described with respect to FIG. 1. The RGD 202 may store one or more applications that may include executable instructions that, when executed by the RGD 202, cause the RGD 202 to perform desired actions, such as to transmit, receive, or otherwise process network messages, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the RGD 202 itself, may be located in the virtual server(s) running in a cloud-based computing environment rather than being tied to one or more specific physical network computing devices. Also, the application(s) may be running in one or more virtual machines (VMs) executing on the RGD 202. Additionally, in one or more embodiments of this technology, virtual machine(s) running on the RGD 202 may be managed or supervised by a hypervisor.

In the network environment 200 of FIG. 2, the RGD 202 is coupled to a plurality of server devices 204(1)-204(n) that hosts a plurality of databases 206(1)-206(n), and also to a plurality of client devices 208(1)-208(n) via communication network(s) 210. A communication interface of the RGD 202, such as the network interface 114 of the computer system 102 of FIG. 1, operatively couples and communicates between the RGD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RGD 202, the server devices 204(1)-204(n), and/or the client devices 208(1)-208(n) may be coupled together via other topologies. Additionally, the network environment 200 may include other network devices such as, for example, one or more routers and/or switches, which are well known in the art and thus will not be described herein. This technology provides several advantages including methods, non-transitory computer-readable media, and RGDs that efficiently implement the method to perform an automated risk grading for assets.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The RGD 202 may be a standalone device or integrated with one or more other devices or apparatuses, such as one or more of the server devices 204(1)-204(n), for example. In one particular example, the RGD 202 may include or be hosted by one of the server devices 204(1)-204(n), and other arrangements are also possible. Moreover, one or more of the devices of the RGD 202 may be in a same or a different communication network including one or more public, private, or cloud-based networks.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the RGD 202 via the communication network(s) 210 according to, for example, the hypertext transfer protocol (HTTP)-based and/or JAVASCRIPT® object notation (JSON) protocol, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store a plurality of data sets coming from a plurality of services, the data required for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within, for example, a cluster architecture, a peer-to-peer architecture, virtual machines, or within a cloud-based architecture. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) may include any type of computing device that can interact with the RGD 202 via communication network(s) 210. Accordingly, the client devices 208(1)-208(n) may be, for example, mobile computing devices, desktop computing devices, laptop computing devices, tablet computing devices, or the like, that host chat, e-mail, or voice-to-text applications. In an exemplary implementation, at least one client device 208 may be a wireless mobile communication device, e.g., a smartphone.

The client devices 208(1)-208(n) may run interface applications, such as standard web browsers or standalone client applications, which may provide an interface to communicate with the RGD 202 via the communication network(s) 210 in order to communicate user requests and information. The client devices 208(1)-208(n) may further include, among other features, a display device, such as a display unit or touchscreen, and/or an input device, such as a keyboard.

Although the exemplary network environment 200 with the RGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RGD 202, the server devices 204(1)-204(n) or the client devices 208(1)-208(n), for example, may be configured to operate as virtual instances on the same physical machine. In other words, one or more of the RGD 202, the server devices 204(1)-204(n), or the client devices 208(1)-208(n) may operate on the same physical device rather than as separate devices communicating through communication network(s) 210. Additionally, there may be more or fewer RGDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

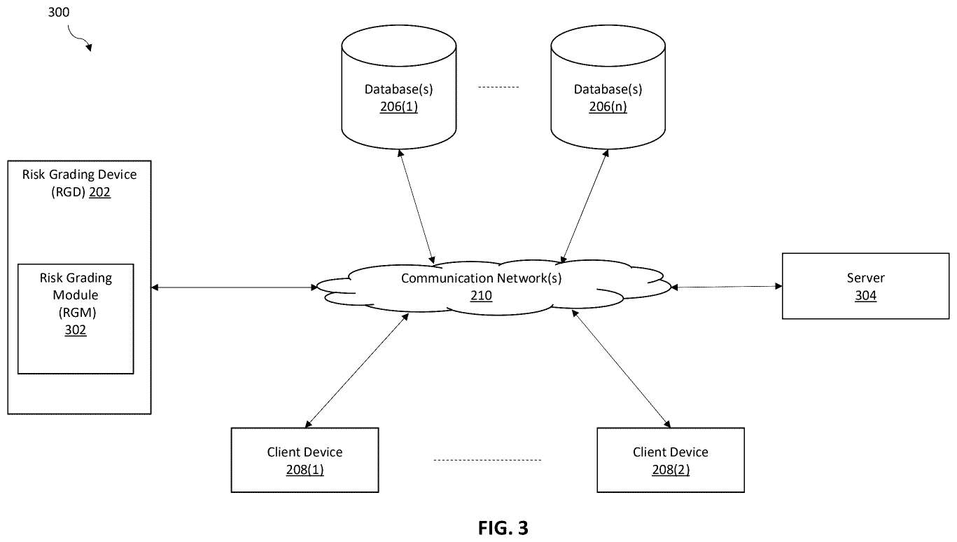

FIG. 3 illustrates a system diagram to perform an automated risk grading for assets in accordance with an exemplary embodiment.

As illustrated in FIG. 3, the system 300 may include a risk grading device (RGD) 202 within which a risk grading module (RGM) 302 may be embedded, a server 304, a repository/database(s) 206(1) . . . 206(n), a plurality of client devices 208(1) . . . 208(2), and a communication network(s) 210 may also be present.

According to exemplary embodiments, the system 300 may comprise the risk grading device (RGD) 202 including the RGM 302 may be connected to the server 304 and the database(s) 206(1) . . . 206(n) via the communication network(s) 210, but the disclosure is not limited thereto. The RGD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the RGD 202 is described and as shown in FIG. 3, may include the RGM 302, although it may include, for example, other rules, policies, modules, databases, or applications. As will be described below, the RGM 302 may be configured to carry out a method to perform an automated risk grading for assets.

An exemplary system 300 for enabling a mechanism to perform an automated risk grading for assets by utilizing the network environment of FIG. 2 may be shown as being executed in FIG. 3. Specifically, a first client device 208(1) and a second client device 208(2) are illustrated as being in communication with RGD 202. In this regard, the first client device 208(1) and the second client device 208(2) may be “clients” of the RGD 202 and are described herein as such. Nevertheless, it may be known and understood that the first client device 208(1) and/or the second client device 208(2) need not necessarily be “clients” of the RGD 202, or any entity described in association therewith herein. Any additional or alternative relationship may exist between either or both of the first client device 208(1) and the second client device 208(2) and the RGD 202, or no relationship may exist.

Further, the RGD 202 may be illustrated as being able to access one or more database(s) 206(1) . . . 206(n). The RGM 302 may be configured to access these repositories/databases to provide a method to perform an automated risk grading for assets. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the RGD 202 via broadband or cellular communication. These embodiments are merely exemplary and are not limiting or exhaustive.

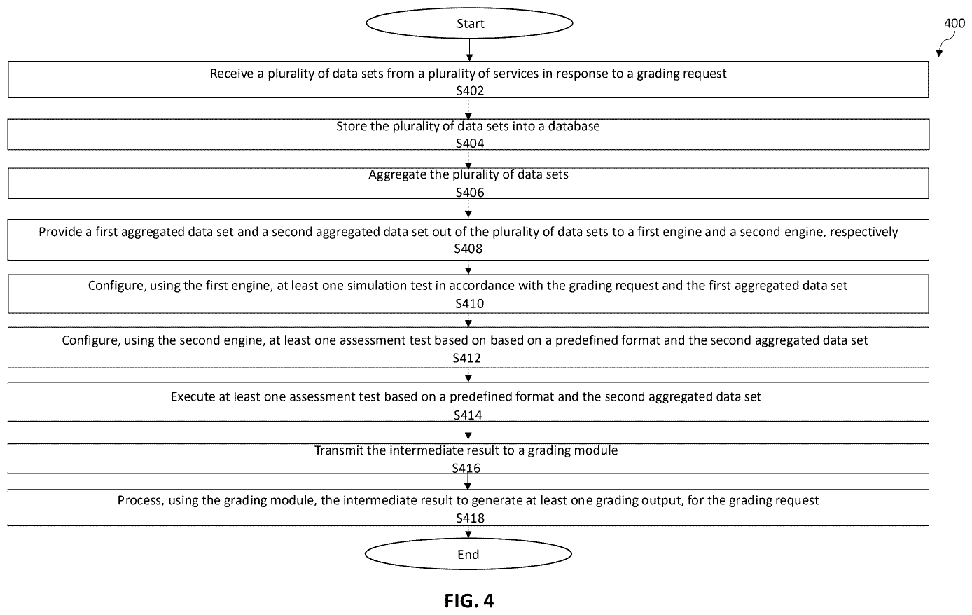

Referring to FIG. 4, an exemplary method 400 is shown to perform an automated risk grading for assets in accordance with an exemplary implementation.

A user may wish to initiate implementing an automated orchestration process to grade commercial assets. The method 400 is implemented by at least one processor 104.

At step S402, the method 400 may include receiving, by the at least one processor, a plurality of data sets from a plurality of services in response to a grading request. The plurality of services may include a loan servicing data service, a credit data service, a portfolio data service, an origination data service, and a client data service. It may also include a Fair Isaac Corporation (FICO) service.

The grading request may typically refer to a process of a quality evaluation or grading of an asset based on the risks of losses associated with it, such as real estate, collectible items, or securities.

The grading request may include at least one from among details of an asset, a property type of the asset, a line of business, and a plurality of simulation parameters. The plurality of simulation parameters may include at least one from among a net operating income change, an interest rate, a change in asset value, stress types, regions, and statistical stress percentage. The stress types may include, but are not limited to, absolute value and relative value. The region may include, but is not limited to, geographical regions or locations such as Northeast, Southwest, and Midwest.

The details of the asset may include at least one from among a name of the asset, location of the asset, age of an asset, and loan details of the asset. The property type of the asset may include, but is not limited to, an apartment, industrial, mixed-use apartment, mixed use commercial real estate (CRE), an office, and/or retail. The line of business may include commercial term lending.

The term “user” as used herein corresponds to a bank official working in one of the various departments of a financial organization, such as a bank.

In an exemplary implementation, the grading request may be raised by the user over a user interface (UI) of an application or a platform through a user device. In some examples, the user device may include one of a tablet, a smartphone, a laptop, a desktop computer, a mainframe computer, a phablet, a smartwatch, a personal digital assistant (PDA), and/or the like. In an exemplary implementation, the UI is operated by the at least one user. The UI may be a graphical user interface (GUI). For example, the GUI may be rendered on a display unit of the user device.

At step S404, the method may include storing, by the at least one processor 104, the plurality of data sets in a database.

The plurality of data sets may include data streams received from the plurality of services. The data stream received from the loan servicing data service may include, but is not limited to, loan services related data of a client, equated monthly instalment (EMI) details, payment regularities and/or payment delinquency. The data stream received from the credit data service may include but is not limited to, a FICO score or a credit score of the client. The data stream received from the portfolio data service may include a net operating income, a rent roll, and an operating statement. The data stream received from the origination data service may include, but is not limited to, a state and the FICO score of the client during an origination of a loan. The data stream received from the client data service may include the current state or information of the client. The data stream received from the FICO service may include the FICO score of the client.

The database may include, but is not limited to, staging tables that may include staging data (e.g., raw data from upstream systems) for each data sourcing service out of the plurality of services and grading data tables. The grading data tables act as main tables in which data received from the staging table first gets validated and then stores such validated data.

In an exemplary implementation, each of the plurality of services may independently source data from their corresponding upstream systems, and stage raw data or raw data files into the staging tables.

At step S406, the method may include aggregating, by the at least one processor 104, the plurality of data sets.

In an exemplary implementation, the at least one processor 104 may process raw data files stored in the staging tables and aggregates such raw data files from the staging tables.

At step S408, the method may include providing, by the at least one processor 104, a first aggregated data set and a second aggregated data set out of the plurality of data sets to a first engine and a second engine, respectively.

The first aggregated data set may include data required for configuring at least one simulation test. The second aggregated data set may include data required for configuring at least one assessment test. For example, the data required for configuring at least one simulation test may include data such as, but not limited to, client repayment data, origination data (e.g., appraisal value, an income and expense data at the time of origination for a property, yearly income and expense reports, etc.), risk related data (e.g., latest risk rating for a client or facility), and market indicators (e.g., property designation). The data required for configuring the at least one assessment test may be similar data as aforementioned in the first aggregated data set, but such data may initially be validated and sanitized, and further be transformed to a format that is required to be supplied to a second engine.

In an exemplary implementation, the first aggregated data set and the second aggregated data set may be retrieved using secure data communication protocols to ensure the integrity and confidentiality of the service data.

At step S410, the method may include configuring, by the at least one processor 104 using the first engine, the at least one simulation test in accordance with the grading request and the first aggregated data set.

The at least one simulation test (e.g., a simulation run) may be configured based on the plurality of simulation parameters that the user wants to tweak or focus to stress on such parameters. The plurality of simulation parameters may include, but are not limited to, a net operating income change, an interest rate, a change in asset value, stress types, regions, and statical stress percentage. This helps the user to perform a customized simulation test according to need. In an example, if the user chooses parameters for an asset such as higher interest rate (e.g., increased interest rate) and change in asset value (e.g., reduced value of such asset), then the at least one simulation test may be executed based on such parameters and an intermediate result of such simulation test may likely to provide risk associated with such asset.

At step S412, the method may include configuring, by the at least one processor 104 using the second engine, the at least one assessment test based on a predefined format and the second aggregated data set.

The predefined format may include predetermined grading schedules for execution of the at least one assessment test (e.g., a grading run).

At step S414, the method may include executing, by the at least one processor 104, the at least one simulation test using the first engine and the at least one assessment test using the second engine to generate an intermediate result.

In an exemplary implementation, generation of the intermediate result may be further based on receiving a response from at least one external service against a request received from at least one of the first engine and the second engine during the execution of the at least one simulation test, and the at least one assessment test, respectively.

The at least one external service may be selected from a loan auto grading service, a probability of default (PD) and loss given default (LGD) auto grading service, and/or an obligor auto grading service.

In an exemplary implementation, after getting the first aggregated data set, the first engine may be configured to create a request which is routed to the at least one external service through an orchestration module. The created request may then be graded using the at least one external service such as PD auto grading service. The first engine may store the response received against the request from the at least one external service and utilizes it for execution of the at least one simulation test. The PD auto grading service may be an independent service designed to be stateless, which accepts an input for grading and produces an output. The input contains several data elements from across all our upstream systems, some market data (as described in one of the answers above) etc. The output may be in the format of grading scores.

The second engine may create a request which may be routed through the orchestration module and then be graded using the at least one external service such as the LGD auto grading service. The second engine may receive a response from the at least one external service and utilizes it for execution of the at least one assessment test.

It may be noted that at least one external service may be stateless and only works on a request and response model. Such external services may have their own schemas (e.g., LGD schema, PD schema, and/or obligor schema) to store intermediate results which may be used during the execution of the at least one assessment test such as configuration analysis tool (CAT) files produced by the at least one external service.

At step S416, the method may include transmitting, by the at least one processor 104, the intermediate result to a grading module.

The intermediate result of both the at least one simulation test and the at least one assessment test may be provided to the grading module to perform orchestration service at the grading module (e.g., auto grading orchestration service).

At step S418, the method may include processing, by the at least one processor 104 using the grading module, the intermediate result to generate at least one grading output for the grading request.

The grading module may process the intermediate result of the at least one simulation test and at least one assessment test and generate the grading output for the received grading request. The at least one grading output may include, but is not limited to, a list of all grading requests along with their corresponding response. For example, the at least one grading output may include a grade against at least one loan that may be assessed, and a probability of default score which may be used to determine the grade for the at least one loan.

In an exemplary implementation, the grading output may include simulated grading output (e.g., simulated PD and LGD grading output), statistical comparison versus simulated tests (e.g., statistical comparison between actual PD and LGD versus simulated run), and simulated risk-weighted assets.

Further, the method may include displaying, by the at least one processor 104 over the UI, the at least one grading output. The at least one grading output may be displayed in at least one visual representation format to provide infographic results based on the grading output to the user. The at least one visual representation format may include bars, charts, tables, and/or statistical comparisons.

The grading module may display a corresponding metadata about tests executed using any of the at least one external service. The metadata may include, but is not limited to, a run identifier, a timestamp information, and/or performance metrics (e.g., a processing time) for the grading request.

In an exemplary implementation, the user may be able to view the grading output (or a list of created or existing grading requests) via a dashboard provided over the UI by the grading module. If the user clicks on the option displayed as “the request to view the grading request” over the UI to provide their input, then the at least one processor 104 causes the UI to display the grading output for the grading request. Also, the user may view and select the list of grading requests retrieved from other applications and the UI displays the status of such grading requests.

The input of the user may include, but is not limited to, a selection of the grading request or a selection of multiple grading requests (from a list of created or the list of existing grading requests).

In an exemplary implementation, the method may include updating, by the at least one processor 104 using the grading module, status of at least one grading request along with the metadata, over at least one external platform (e.g., KAFKA®) to notify the user about status of their grading request.

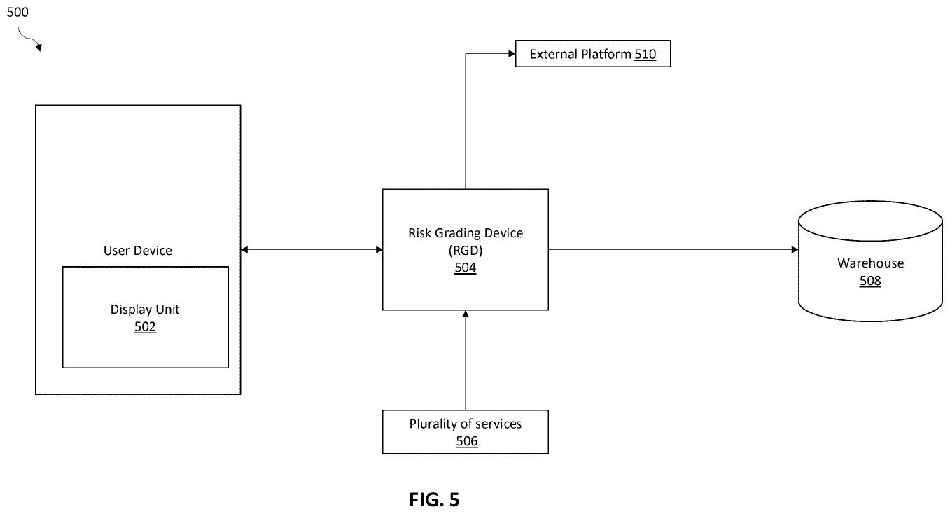

FIG. 5 illustrates a block diagram that represents a system that may perform an automated risk grading for assets in accordance with an exemplary embodiment. As illustrated in FIG. 5, the process flow 500 begins with receiving, by a risk grading device (RGD) 504, a grading request raised by a user over an application (e.g., representational state transfer (REST) application). The RGD 504 may receive a plurality of data sets from a plurality of services 506 and store the plurality of data sets in a database (also referred to herein as warehouse 508) in response to the grading request.

In an exemplary implementation, the application may be installed in a user device. A user interface (UI) of the application may be a graphical user interface (GUI). For example, the UI may be rendered on a display unit 502 of the user's device. In some examples, the user device may include one of a tablet, a smartphone, a laptop, a desktop computer, a mainframe computer, a phablet, a smart watch, a personal digital assistant (PDA), and/or the like.

In an exemplary implementation, the RGD 504 may configure at least one simulation test and at least one assignment test using aggregated plurality of datasets received from the database 508. The RGD 504 may be configured to generate a grading output based upon processing intermediate results of the at least one simulation test and the at least one assignment test. Finally, the RGD 504 may display the grading output over the UI which is rendered over the display unit 502 to display such grading output to the user. The user is able to view the grading output through the display unit 502 of the user device.

Thus, the RGD 504 may perform an automated risk grading for assets in response to the grading request. Further, the RGD 504 may transmit a notification to the user upon successful generation of the grading output. The RGD 504 may send the grading output to the warehouse 508 to store it for reference purposes. This grading output may be further pushed out to downstream systems such as event-driven architecture (EDH) over at least one external platform 510 (e.g., KAFKA®). Further, the RGD 504 may update, using the grading module, status of the grading request along with its metadata over the at least one external platform 510 (e.g., KAFKA®) to notify the user about status of their grading request.

It would be appreciated by the person skilled in the art that the RGD 504 offers a full-circle, adaptable, and an intelligent solution for implementing a method to perform an automated risk grading for assets.

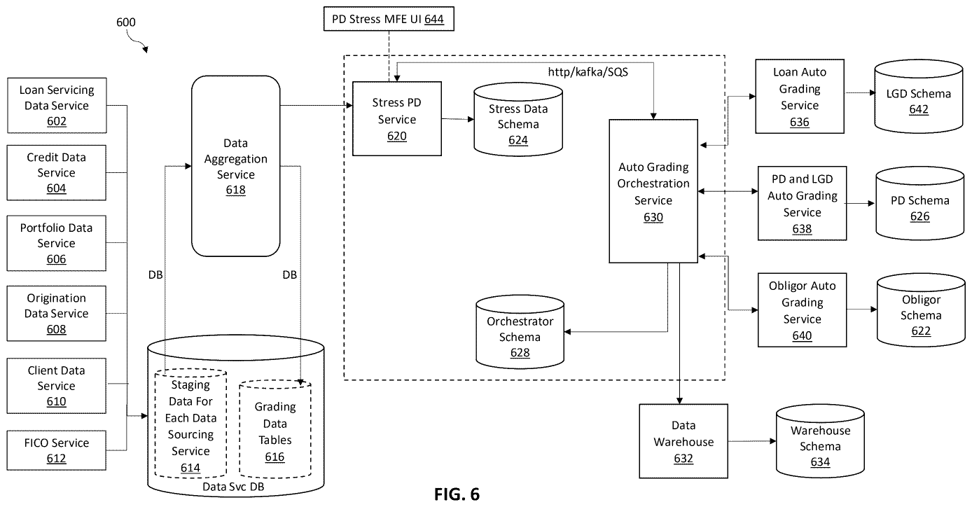

As shown in FIG. 6, an exemplary system architecture may depict a process of performing an automated risk grading for assets in accordance with an exemplary embodiment of the present disclosure.

Referring to FIG. 6, the system 600 may receive data from a plurality of services in response to a grading request raised by a user. The grading request may include at least one among details of an asset, a property type of the asset, a line of business, and a plurality of simulation parameters. The plurality of services may independently source data from their corresponding upstream systems and stage raw data into staging tables. The staging tables are stored in a database. The database may include the staging tables and grading data tables. The plurality of data services may include, but are not limited to, a loan servicing data service 602, a credit data service 604, a portfolio data service 606, an origination data service 608, a client data service 610 and a FICO service 612.

In an exemplary implementation, the data received from the loan servicing data service 602 may include, but not limited to, loan services associated data of a client, equated monthly installment (EMI) details, payment regularities, and/or payment delinquency. The data received from the credit data service 604 may include such as, but not limited to, a FICO score or a credit score of the client. The data received from the portfolio data service 606 may include, but not limited to, a net operating income, a rent roll, and/or an operating statement. The data received from the origination data service 608 may include, but not limited to, a state and a FICO score of the client during loan origination. The data received from the client data service 610 may include such as, but not limited to, latest or current state or information of the client. The data received from the FICO service 612 may include, but not limited to, a FICO score of the client. The data received from the plurality of services may generate a plurality of data sets.

The system 600 may include a data aggregation service 618, which may receive and process data associated with at least one data sourcing service out of the plurality of data services. In an exemplary implementation, the data aggregation service 618 aggregates the plurality of data sets. The data aggregation service 618 may aggregate data from the staging tables. The data aggregation service 618 may further be configured to create grading data tables 616 in the database. The data aggregation service 618 may further provide an output data such as a first aggregated data set to a stress probability of default (PD) service 620. The stress PD service 620 may have all the logic that may be applied to at least one simulation test (e.g., simulation run). The stress PD service 620 may configure the least one simulation test in accordance with the grading request and the first aggregated data set. Thus, the first aggregated data set may be sourced from the data aggregation service 618 and manipulated based on the simulation parameters given in the grading request. Further, the stress PD service 620 may create a request which may be routed through an auto grading orchestration service 630 that to be graded using a PD auto grading service 638. The response may be stored in the stress PD service 620 and a PD stress micro front end (MFE) UI 644 (hereinafter referred to as PD stress MFE) may allow the user to perform all these actions and control the simulation runs. The PD stress MFE 644 may be a user interface which may include a simulation module. The PD stress MFE 644 may track the status of each run and show the user detailed results of each simulation run after the grading run is completed.

Further, the stress PD service 620 may send intermediate result(s) of the at least one simulation test to the auto grading orchestration service 630. The auto grading orchestration service 630 may process the intermediate result(s) to generate at least one grading output, for the grading request. The at least one grading output may include, but is not limited to, a list of all grading requests along with their corresponding response. The auto grading orchestration service 630 may include all grading requests and their corresponding response and a status of such requests, and provide metadata about each of the simulation and assignment test that were made to any of the grading services. The auto grading orchestration service 630 may also expose representational state transfer (REST) application programming interfaces (APIs) for other applications to use grading-as-a service. The grading orchestration service 630 may be responsible for storing the request or response data and publishing updates along with a notification on at least one external platform (e.g., KAFKA®) for any requests coming in from other users. Such notifications only have metadata about the request, so each user may choose to get the complete response through the REST API. Further, the auto grading orchestration service 630 may provide a dashboard where it may list outputs of all tests that were requested and their status.

Finally, the auto grading orchestration service 630 may send the grading output to a data warehouse 632. The data warehouse 632 stores the data received from the auto grading orchestration service 630.

Furthermore, the auto grading orchestration service 630 may interact with a loan auto grading service 636, a PD and LGD service 638, and an obligor auto grading service 640 to exchange required data for implementing the features of the present disclosure. These services (e.g., the loan auto grading service 636, the PD and LGD service 638, and the obligor auto grading service 640) may be nearly stateless and only work on a request and response model. Such services may have their own schemas (e.g., the LGD schema 642, PD schema 624, and the obligor schema 622) to store intermediate results which will be used during the grading runs such as configuration analysis tool (CAT) files which may be produced by the PD auto grading service 638, and later used by such service again during the whole risk grading process.

The present disclosure provides numerous advantages as given below. The present disclosure allows users to generate a grading request to evaluate risk associated with a lending portfolio and provides a grading output stating risk grading of commercial assets and lending portfolio. The present disclosure provides a status of their grading request along with details about every grading run to users. The present disclosure provides a solution to automate tasks such as risk grading for commercial assets and lending portfolio. The present disclosure helps in evaluating risk associated with lending portfolio of commercial assets and avoids adverse economic impact on the lending portfolio. This enables business leadership and financial institutions to quickly assess potential risk implications by simulating changes to markets, strategy, capital requirements, or other environmental factors.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather, the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and/or other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to perform an automated risk grading for assets is disclosed. The instructions include executable code which, when executed by a processor 104, may cause the processor 104 to receive, a plurality of data sets from a plurality of services in response to a grading request; store the plurality of data sets in a database; aggregate the plurality of data sets; provide a first aggregated data set and a second aggregated data set out of the plurality of data sets to a first engine and a second engine, respectively; configure, using the first engine, at least one simulation test in accordance with the grading request and the first aggregated data set; configure, using the second engine, at least one assessment test based on a predefined format and the second aggregated data set; execute the at least one simulation test using the first engine and the at least one assessment test using the second engine to generate an intermediate result; transmit the intermediate result to a grading module; and process, using the grading module, the intermediate result to generate at least one grading output for the grading request.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method to perform an automated risk grading for assets, the method being implemented by at least one processor, the method comprising:
receiving, by the at least one processor, a plurality of data sets from a plurality of services in response to a grading request;
storing, by the at least one processor, the plurality of data sets in a database;
aggregating, by the at least one processor, the plurality of data sets;
providing, by the at least one processor, a first aggregated data set and a second aggregated data set out of the plurality of data sets to a first engine and a second engine, respectively;
configuring, by the at least one processor using the first engine, at least one simulation test in accordance with the grading request and the first aggregated data set;
configuring, by the at least one processor using the second engine, at least one assessment test based on a predefined format and the second aggregated data set;
executing, by the at least one processor, the at least one simulation test using the first engine and the at least one assessment test using the second engine to generate an intermediate result;
transmitting, by the at least one processor, the intermediate result to a grading module; and
processing, by the at least one processor using the grading module, the intermediate result to generate at least one grading output for the grading request.

2. The method as claimed in claim 1, wherein the grading request comprises at least one from among details of an asset, a property type of the asset, a line of business, and a plurality of simulation parameters.

3. The method as claimed in claim 2, wherein the plurality of simulation parameters comprises at least one from among a net operating income change, an interest rate, a change in asset value, stress types, and regions.

4. The method as claimed in claim 1, wherein the plurality of services comprises at least one from among a loan servicing data service, a credit data service, a portfolio data service, an origination data service, and a client data service.

5. The method as claimed in claim 1, wherein the first aggregated data set comprises a data required for configuring the at least one simulation test.

6. The method as claimed in claim 1, wherein the second aggregated data set comprises a data required for configuring the at least one assessment test.

7. The method as claimed in claim 1, wherein the method further comprises displaying, by the at least one processor over a user interface (UI), the at least one grading output.

8. The method as claimed in claim 1, wherein generating the intermediate result is further based on receiving a response from at least one external service against a request received from at least one of the first engine and the second engine.

9. A computing device configured to perform an automated risk grading for assets, the computing device comprising:
a processor;
a memory; and
a communication interface coupled to each of the processor and the memory, wherein the processor is configured to:
receive a plurality of data sets from a plurality of services in response to a grading request;
store the plurality of data sets in a database;
aggregate the plurality of data sets;
provide a first aggregated data set and a second aggregated data set out of the plurality of data sets to a first engine and a second engine, respectively;
configure, using the first engine, at least one simulation test in accordance with the grading request and the first aggregated data set;
configure, using the second engine, at least one assessment test based on a predefined format and the second aggregated data set;
execute the at least one simulation test using the first engine and the at least one assessment test using the second engine to generate an intermediate result;
transmit the intermediate result to a grading module; and
process, using the grading module, the intermediate result to generate at least one grading output for the grading request.

10. The computing device as claimed in claim 9, wherein the grading request comprises at least one from among details of an asset, a property type of the asset, a line of business, and a plurality of simulation parameters.

11. The computing device as claimed in claim 10, wherein the plurality of simulation parameters comprises at least one from among a net operating income change, an interest rate, a change in asset value, stress types, and regions.

12. The computing device as claimed in claim 9, wherein the plurality of services comprises at least one from among a loan servicing data service, a credit data service, a portfolio data service, an origination data service, and a client data service.

13. The computing device as claimed in claim 9, wherein the first aggregated data set comprises a data required for configuring the at least one simulation test.

14. The computing device as claimed in claim 9, wherein the second aggregated data set comprises a data required for configuring the at least one assessment test.

15. The computing device as claimed in claim 9, wherein the processor is further configured to display the at least one grading output over a user interface (UI).

16. The computing device as claimed in claim 9, wherein generation of the intermediate result is based on a reception of a response from at least one external service against a request received from at least one of the first engine and the second engine.

17. A non-transitory computer readable storage medium storing instructions to perform an automated risk grading for assets, the storage medium comprising executable code which, when executed by a processor, causes the processor to:
receive a plurality of data sets from a plurality of services in response to a grading request;
store the plurality of data sets in a database;
aggregate the plurality of data sets;
provide a first aggregated data set and a second aggregated data set out of the plurality of data sets to a first engine and a second engine, respectively;
configure, using the first engine, at least one simulation test in accordance with the grading request and the first aggregated data set;
configure, using the second engine, at least one assessment test based on a predefined format and the second aggregated data set;
execute the at least one simulation test using the first engine and the at least one assessment test using the second engine to generate an intermediate result;
transmit the intermediate result to a grading module; and
process, using the grading module, the intermediate result to generate at least one grading output for the grading request.

18. The storage medium as claimed in claim 17, wherein the grading request comprises at least one from among details of an asset, a property type of the asset, a line of business, and a plurality of simulation parameters.

19. The storage medium as claimed in claim 18, wherein the plurality of simulation parameters comprises at least one from among a net operating income change, an interest rate, a change in asset value, stress types, and regions.

20. The storage medium as claimed in claim 17, wherein the plurality of services comprises at least one from among a loan servicing data service, a credit data service, a portfolio data service, an origination data service, and a client data service.
